(19) United States
(12) Patent Application Publication
(10) Pub. No.: US 2023/0004860 A1
(43) Pub. Date: Jan. 5, 2023

(54) DETERMINING A HYPERPARAMETER FOR INFLUENCING NON-LOCAL SAMPLES IN MACHINE LEARNING

(71) Applicant: salesforce.com, inc., San Francisco, CA (US)

(72) Inventors: Donglin Hu, San Francisco, CA (US); Yuxi Zhang, San Francisco, CA (US); Kexin Xie, San Mateo, CA (US)

(21) Appl. No.: 17/366,249

(22) Filed: Jul. 2, 2021

(51) Int. Cl. G06N 20/00; G06N 7/00

(52) U.S. Cl. CPC G06N 20/00; G06N 7/005

(57) ABSTRACT

Methods, computer readable media, and devices for determining a hyperparameter for influencing non-local samples in machine learning are disclosed. One method may include identifying a set of local samples associated with a first entity, identifying a set of non-local samples comprising samples associated with a plurality of entities other than the first entity, assigning a local sample weight to one or more samples of the set of local samples, determining a range of non-local sample weights, determining a range of hyperparameters based on the range of non-local sample weights, determining an optimized hyperparameter based on the range of hyperparameters, assigning an optimized non-local sample weight to one or more samples of the set of non-local samples, and generating a prediction using machine learning.

### TECHNICAL FIELD

Embodiments disclosed herein relate to techniques and systems for determining a hyperparameter for influencing non-local samples in machine learning.

### BACKGROUND

Machine learning may be utilized by a prediction system to enable making business decisions. Generally, such prediction system may generate predictions about behaviors and engagement (e.g., email open rate, link click through rate, engagement frequency) of users of a single entity (e.g., customers of a retailer). For example, data about users' behaviors and engagement patterns may be analyzed to extract features to be used as inputs for the prediction system. However, a single entity may have limited data and the prediction may suffer from an under-fitting problem because the prediction model may not have sufficient data from which to learn.

In order to overcome under-fitting, data from a plurality of entities may be utilized in a global model. The global model may be trained by pooling data from multiple entities together. However, such approach makes a false assumption that customers behave the same across different entities. As such, the resulting model may lack personalization for an individual entity.

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description explain the principles of implementations of the disclosed subject matter. No attempt is made to show structural details in more detail than can be necessary for a fundamental understanding of the disclosed subject matter and various ways in which it can be practiced.

FIG. 1A is a block diagram illustrating a system for use with determining a hyperparameter for influencing non-local samples in machine learning according to some example implementations.

FIG. 1B illustrates a sample table of a range of contribution ratios and sample weights for use with determining a hyperparameter for influencing non-local samples in machine learning according to some example implementations.

FIG. 1C illustrates an example of a trade-off continuum between a global model and a local model controlled by a contribution ratio according to some example implementations.

FIG. 1D illustrates a set of sample charts of results based on determining a hyperparameter for influencing non-local samples in machine learning according to some example implementations.

FIG. 2 is a flow diagram illustrating a method for use with determining a hyperparameter for influencing non-local samples in machine learning according to some example implementations.

FIG. 3A is a block diagram illustrating an electronic device according to some example implementations.

FIG. 3B is a block diagram of a deployment environment according to some example implementations.

### DETAILED DESCRIPTION

Various aspects or features of this disclosure are described with reference to the drawings, wherein like reference numerals are used to refer to like elements throughout. In this specification, numerous details are set forth in order to provide a thorough understanding of this disclosure. It should be understood, however, that certain aspects of disclosure can be practiced without these specific details, or with other methods, components, materials, or the like. In other instances, well-known structures and devices are shown in block diagram form to facilitate describing the subject disclosure.

Embodiments disclosed herein provide techniques, systems, and devices that allow for determining a hyperparameter for influencing non-local samples in machine learning. In particular, disclosed embodiments may enable identifying an optimized hyperparameter from among a range of hyperparameters for use in a machine learning-based prediction system.

In various implementations, the objective of model training for a general supervised machine learning problem may be to minimize the dissimilarity between targets and predictions. For example, mean squared error may be used for regression and cross entropy may be used for classification. Generally, a formula of this optimization may be rewritten as:

$$min L ( y , \hat{y} ) = \frac{1}{N} {\sum }_{i} {w}_{i} \times L ( {y}_{i} , {\hat{y}}_{i} )$$

where yᵢ is the i^{th} target, ŷᵢ is the i^{th} prediction, and L(yᵢ,ŷᵢ) is a loss function measuring dissimilarity scores between targets and predictions. wᵢ is a sample weight which determines how important the i^{th} data sample is in the model. Be default, w is set to be 1 for all samples in a global model. Such sample weight also controls the contribution to the model. If the weight wᵢ is zero, the i^{th} data sample is not used at all in the model. If the sample weight is doubled to two, it is equivalent to adding a duplicate i^{th} data sample to the model.

When working with data samples of multiple entities or tenants, model boosting may be performed by optimizing weight values. Given tenant A (from among multiple tenants), higher weights may be intuitively given to samples more relevant to tenant A while reducing weights assigned to other, non-tenant A, samples. However, it may be difficult to determine how relevant between tenant A and non-tenant A samples without well-defined metrics. In addition, it may require per sample level computation which may not be feasible in some cases.

To address this problem, in some implementations weights may be assigned at a tenant level (e.g., tenant A and non-tenant A) and allow samples from the same tenant to share the same sample weight (e.g., a first weight for tenant A samples and a second weight for non-tenant A samples). This may alleviate the problem significantly when the number of tenants (e.g., individual entities) is small. However, it may become severe when the number of tenants grows. Another approach to solve this problem may be segmentation. Segmentation may be achieved by dividing tenants into a small number of groups and treating each group as a big virtual tenant. In this way, a strong assumption may be made that tenants in the same group have the same characteristics. In this situation, the accuracy of a prediction system may rely on not only core prediction models, but also the quality of upstream clustering algorithms. This approach (i.e., segmentation) may become more challenging to debug and tune the system because of the additional complexity. Thus, a simplified but effective solution that provides weight adjustment between tenant A and non-tenant A data samples is needed.

Implementations of the disclosed subject matter provide methods, computer readable media, and devices for determining a hyperparameter for influencing non-local samples in machine learning. In various implementations, a method for determining a hyperparameter for influencing non-local samples in machine learning may include identifying a set of local samples associated with a first entity, identifying a set of non-local samples including samples associated with a plurality of entities other than the first entity, assigning a local sample weight to one or more samples of the set of local samples, determining a range of non-local sample weights, determining a range of hyperparameters based on the range of non-local sample weights, determining an optimized hyperparameter based on the range of hyperparameters, assigning an optimized non-local sample weight, based on the optimized hyperparameter, to one or more samples of the set of non-local samples, and generating a prediction using machine learning. In some implementations, the prediction may be associated with the first entity and may be based on the set of local samples, the set of non-local samples, the local sample weight, and the optimized non-local sample weight.

In some implementations, the local sample weight may be 1.

In some implementations, the range of non-local sample weights may be between a total number of samples in the set of local samples over a total number of samples in the set of local samples and the set of non-local samples and the integer value 1.

In some implementations, determining a range of hyperparameters based on the range of non-local sample weights may include, for any one non-local sample weight, determining an associated hyperparameter to be a ratio of a total number of samples in the set of local samples to a difference between a total number of samples in the set of non-local samples and the total number of samples in the set of local samples multiplied by the one non-local sample weight plus the total number of samples in the set of local samples.

In some implementations, determining a range of hyperparameters based on the range of non-local sample weights may include, for any one non-local sample weight, determining an associated hyperparameter to be a ratio of a total number of samples in the set of local samples multiplied by the local sample weight to a difference between a total number of samples in the set of non-local samples and the total number of samples in the set of local samples multiplied by the one non-local sample weight plus the total number of samples in the set of local samples multiplied by the local sample weight.

In some implementations, determining a range of hyperparameters based on the range of non-local sample weights may include, for any one non-local sample weight, determining an associated hyperparameter to be a ratio of a sum of local sample weights assigned to the one or more samples of the set of local samples to a sum of non-local sample weights assigned to the one or more samples of the set of non-local samples plus the sum of local sample weights assigned to the one or more samples of the set of local samples.

In some implementations, determining an optimized hyperparameter based on the range of hyperparameters may include performing a grid search.

In some implementations, determining an optimized hyperparameter based on the range of hyperparameters may include utilizing a Bayesian optimization.

In some implementations, the prediction may be a prediction of an action to be taken by one or more individuals associated with the first entity.

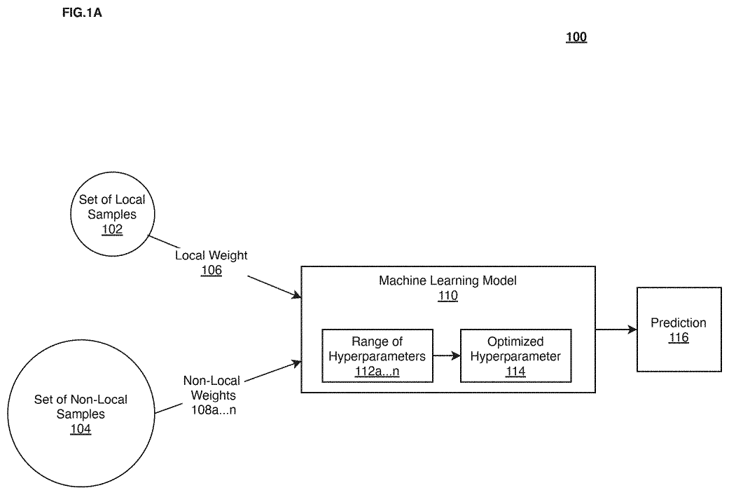

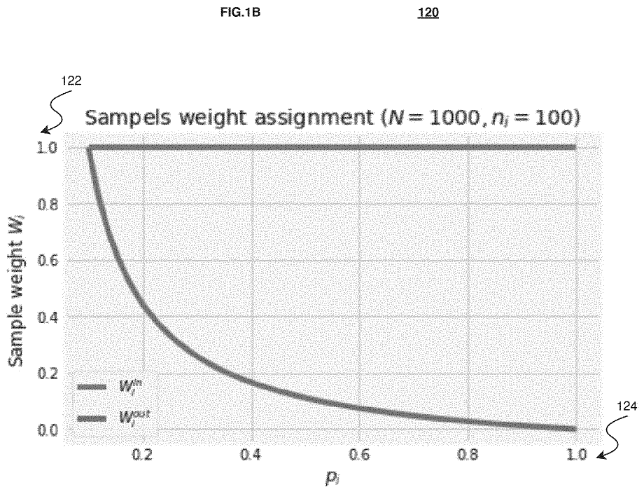

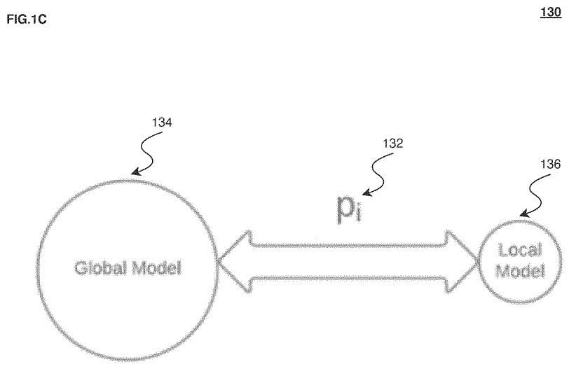

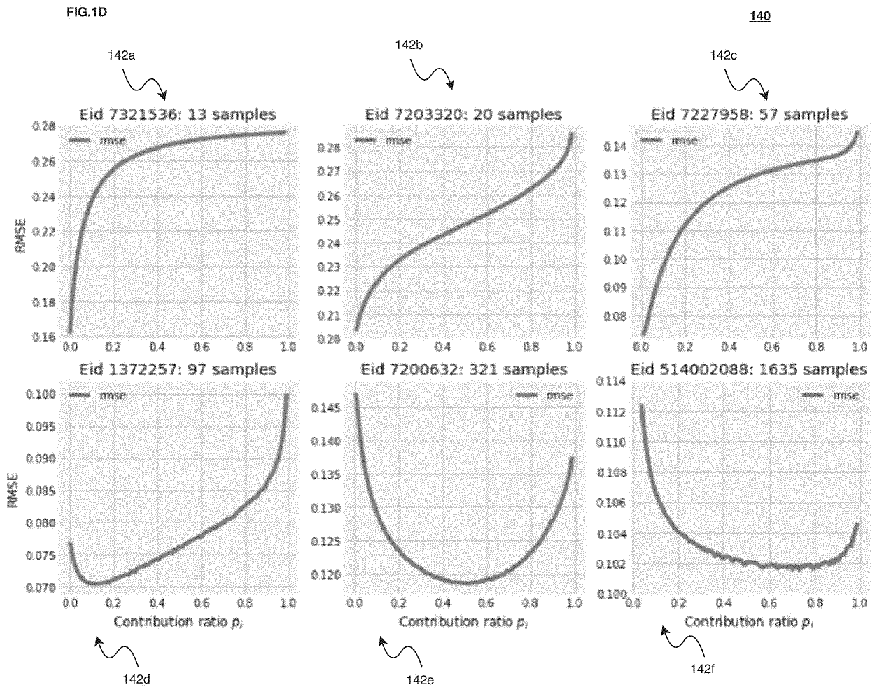

FIG. 1A illustrates a system 100 for use with determining a hyperparameter for influencing non-local samples in machine learning according to various implementations of the subject matter disclosed herein. In various implementations, system 100 may include, for example, machine learning model 110 that functions or otherwise serves as a prediction system to generate prediction 116. Prediction 116 may represent, for example, a prediction about future user behavior, such as behavior of users of a single entity. For example, an entity, such as a retailer, may want to predict how users associated with the entity, such as customers, may respond or otherwise engage with the entity, such as in response to a mailer, flyer, email, web ad, or the like. Although prediction 116 is shown as a singular prediction, this is only for simplicity and the prediction may represent a collection of predictions.

In various implementations, system 100 may include, for example, a set of local samples 102 and a set of non-local samples 104. The set of local samples 102 may include, for example, data samples associated with a single entity. The set of non-local samples 104 may include, for example, data samples associated with a plurality of entities other than the single entity. The data samples, either local or non-local, may represent actions and/or behaviors of various users. For example, local data samples may represent behavior of users associated with the single entity (e.g., customers of a retailer) and non-local data samples may represent behavior of users associated with the plurality of other entities.

In various implementations, local weight 106 may be assigned to one or more data samples of the set of local data samples 102. In addition, a range of non-local weights 108a . . . n may be defined in association with the set of non-local samples 104. In various implementations, a range of hyperparameters 112a . . . n may be determined based on the range of non-local weights 108a . . . n. As used herein, a “hyperparameter” has its normal meaning in machine learning and refers to a parameter of a machine learning system that is used to control one or more aspects of the learning process of the system, as opposed to other parameters that may be derived based on training._{[A1]}An optimized hyperparameter 114 may be selected from the range of hyperparameters 112a . . . n. As used herein, a hyperparameter is “optimized” if it is more optimal, i.e., more computationally efficient, than one or more other hyperparameters. Thus, an “optimized” hyperparameter need not be the “most optimized” hyperparameter for a given situation. More generally, unless indicated to the contrary, a metric or variable is “optimized” if it is more efficient or otherwise more optimal than one or more other values of the same metric or variable. For example, machine learning model 110 may be repeatedly utilized with one or more hyperparameters 112a . . . n. Based on the results, the optimized hyperparameter 114 may be selected as the hyperparameter that enables machine learning model 110 to generate a more accurate prediction. Based on the optimized hyperparameter 114, an optimized non-local weight may be assigned to one or more data samples of the set of non-local data samples 104.

Of note, the set of local samples 102 may include an insufficient number of data samples from which machine learning model 110 may learn in order to generate an accurate prediction 116. However, since the set of non-local samples 104 includes data samples from other entities, the user behavior represented by those data samples may not be consistent with user behavior represented by the set of local samples 102. For example, the set of non-local samples 104 may include data samples from different types of entities and/or various types of users. The single entity may be, for example, a brick-and-mortar retailer while the other entities may include, for example, online retailers, news sites, banks, brick-and-mortar retailers, informational websites, streaming services, and the like. By assigning an optimized non-local weight based on the optimized hyperparameter 114 to the set of non-local samples 104, machine learning model 110 may have a sufficient number of data samples from which to learn while limiting any impact of dissimilarity of the other entities.

In various implementations, a given entity or tenant may correspond to the i^{th} entity and a local weight Wᵢⁱⁿ may be assigned to data samples associated with the given entity (i.e., set of local data samples). Without loss of generality, the local weight Wᵢⁱⁿ may be set to 1 for the set of local data samples. In various implementations, a non-local weight Wᵢ^{out} may be assigned to data samples associated with entities other than the given entity (i.e., set of non-local data samples). The formula for determining local and non-local weights may be:

$$\{ \begin{matrix}{W}_{i}^{in} = 1 & for data in the set of local data sampels \\ {W}_{i}^{out} = \frac{1 - {p}_{i}}{{p}_{i}} \frac{{n}_{i}}{N - {N}_{i}} & for data in the set of non - local data samples\end{matrix} \\ where {p}_{i} = [ \frac{{n}_{i}}{N} , 1 ]$$

and pᵢ is a contribution ratio which may determine contribution ratio of the given entity's data samples from among the pooled data (i.e., collection of local and non-local data samples). Nis a total number of training samples across all entities and nᵢ is the number of training samples from the i^{th} entity (i.e., the given entity or tenant). Based on this sample weight formula, performance of a machine learning model may be evaluated against different pᵢ values. FIG. 1B illustrates a sample table 120 of a range of contribution ratios 124 and sample weights 122 based on 1000 total data samples and 100 local data samples.

In various implementations, there are two special cases corresponding to two end points of the interval as depicted in FIG. 1B.

$$\cdot Case {p}_{i} = \frac{{n}_{i}}{N} :$$

Wᵢ^{out} (curved line in FIG. 1B) becomes 1 and all data samples share the same weight 1. This is the same as the global model.

Case pᵢ=1:Wᵢ^{out} (curved line in FIG. 1B) becomes 0 and all non-local data samples (i.e., data samples associated with entities other than the given entity) are not used to train the model. This is equivalent to an individual local model.

In various implementations, modeling using the sample weight formula may be considered as a general form of global (with purely pooled data) and local (with only individual data) modeling. pᵢ may control the trade-off between global and local models. A smaller pᵢ may let the model suffer from the loss of personalized information and may bring bias from heterogenous entities while a larger pᵢ may under fit the model if the sample size is not large enough. FIG. 1C illustrates an example model 130 of a trade-off continuum between a global model 134 and a local model 136 controlled by a contribution ratio 132. As shown in FIG. 1C, this contribution ratio (i.e., pᵢ) may be a trade-off between over-fitting and under-fitting. Due to continuous property, there must exist an optimal pᵢ within the interval for the best prediction accuracy.

FIG. 1D illustrates a set of sample charts 140 of results based on determining a hyperparameter for influencing non-local samples in machine learning. As shown in FIG. 1D, modeling using the sample weight formula disclosed herein was applied to real data to generate a prediction related to an email open rate. Root mean squared error (RMSE) was used as a metric to evaluate the prediction accuracy for each entity. In particular, RMSE was calculated with different pᵢ values from the interval

$$[ \frac{{n}_{i}}{N} , 1 ] .$$

The leftmost and rightmost point are corresponding to global model and local model respectively. As shown in charts 142a, 142b, 142c, the three entities with small sample size favor global model. As shown in charts 142d, 142e, 142f, the three entities with large sample size prefer to make trade-offs between global and local models. In general, an entity with a very large sample size (e.g., tens of thousands of samples) may favor local model.

In various implementations, to identify an optimal pᵢ value (i.e., optimal hyperparameter), a grid search may be used. For example, candidates for an optimal pᵢ value may be generated from an interval, such as the list [0.1, 0.3, 0.5, 0.7, 0.9]. In this example, pᵢ may be selected from the list. In particular, each pᵢ value from the list may be used to calculate sample weights. A machine learning model may be fitted with the various calculated weights and performance may be evaluated based on predefined metrics (e.g., RMSE). As shown in chart 142e of FIG. 1D, a relationship between RMSE and pᵢ may be identified. By comparing all RMSE values, an optimal pᵢ value may be retained. For example, as shown in chart 142e of FIG. 1D, an optimal pᵢ value may be selected as 0.5.

Grid search may be the simplest way to find an optimal pᵢ value. For example, grid search may not take past evaluation results into account. A whole range of an interval may need to be searched in order to find an pᵢ value. As shown in FIG. 1D, a positive correlation may be observed between a size of the set of local data samples (i.e., sample size of the given entity) and the optimal pᵢ value. The larger the sample size, the higher the optimal pᵢ value. Such relationship may be used as a prior to generate a pᵢ distribution which may help reduce the searching ranges of the optimal pᵢ values.

In various implementations, Bayesian optimization may be used to identify an optimal pᵢ value. For example, Bayesian optimization may be used to predict an optimal pᵢ value using Gaussian processes.

In various implementations, a sample weight formula for Wᵢ^{out} such as disclosed herein may be transformed to identify the following equations for pᵢ:

$$\begin{matrix}{p}_{i} = \frac{{n}_{i}}{( N - {n}_{i} ) \times {W}_{i}^{out} + {n}_{i}} \\ = \frac{{n}_{i} \times {W}_{i}^{in}}{( N - {n}_{i} ) \times {W}_{i}^{out} + {n}_{i} \times {W}_{i}^{in}} \\ = \frac{sum of weights from target entity}{\begin{matrix}sum of weights from non - target entities + \\ sum of weights from target entity\end{matrix}}\end{matrix}$$

The second equation is because Wᵢⁱⁿ is always 1. The third equation is due to the definition. Thus, pᵢ is the sum of a given entity's data sample weights over the sum of the pooled data's sample weights.

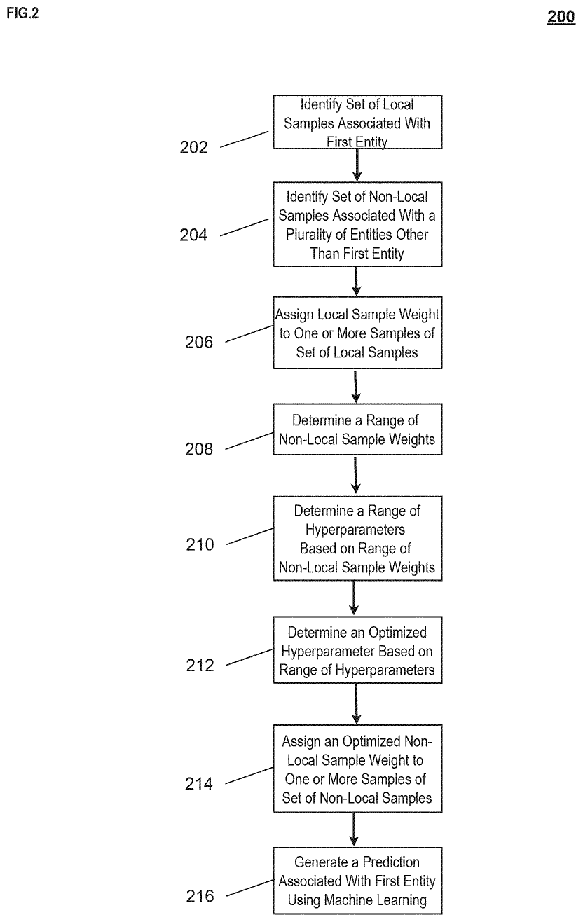

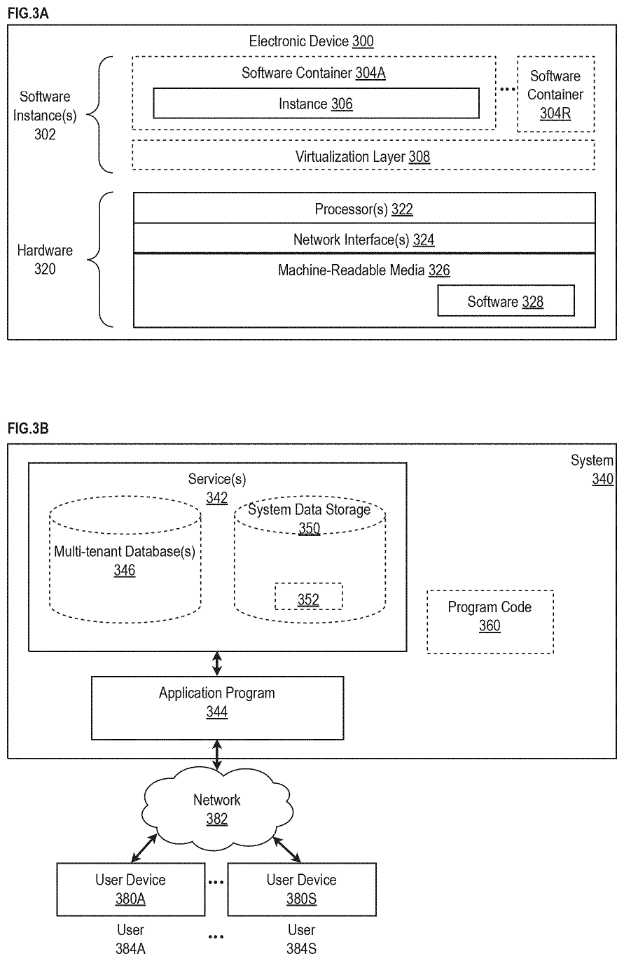

FIG. 2 illustrates a method 200 for determining an optimized hyperparameter for influencing non-local samples in a machine learning prediction model, as disclosed herein. In various implementations, the steps of method 200 may be performed by a server, such as electronic device 300 of FIG. 3A or system 340 of FIG. 3B, and/or by software executing on a server or distributed computing platform. Although the steps of method 200 are presented in a particular order, this is only for simplicity.

In step 202, a set of local samples associated with a first entity may be identified. For example, data samples representing actions and/or behaviors of users associated with the first entity may be collected or otherwise identified for inclusion in the set of local samples. In various implementations, the first entity may be, for example, an organization or business, such as a retailer, a web site, a service provider, a bank, or the like.

In step 204, a set of non-local samples associated with a plurality of entities other than the first entity may be identified. In various implementations, the plurality of other entities may include, for example, organizations or businesses that are similar and/or different from the first entity. For example, while the first entity may be a retailer, the plurality of other entities may include retailers as well as other types of organizations or businesses. In another example, while the first entity may be a retailer, the plurality of other entities may not include a retailer and instead only include organizations or businesses of different types.

In step 206, a local sample weight may be assigned to one or more samples of the set of local samples. In some implementations, the local sample weight may be 1.

In step 208, a range of non-local sample weights may be determined. In some implementations, the range of non-local sample weights may be between a total number of samples in the set of local samples over a total number of samples in the set of local samples and the set of non-local samples and the integer value 1. In some implementations, the range of non-local weights may be identified as

$${W}_{i}^{out} = \frac{1 - {p}_{i}}{{p}_{i}} \frac{{n}_{i}}{N - {n}_{i}}$$

where pᵢ is a hyperparameter whose value may be used to control a learning process in machine learning, N is the total number of all samples, and nᵢ is the number of samples for the target entity.

In step 210, a range of hyperparameters may be determined based on the range of non-local sample weights. In some implementations, the range of hyperparameters may be determined by, for any one non-local sample weight, determining an associated hyperparameter to be a ratio of a total number of samples in the set of local samples to a difference between a total number of samples in the set of non-local samples and the total number of samples in the set of local samples multiplied by the one non-local sample weight plus the total number of samples in the set of local samples. In some implementations, the range of hyperparameters may be determined by, for any one non-local sample weight, determining an associated hyperparameter to be a ratio of a total number of samples in the set of local samples multiplied by the local sample weight to a difference between a total number of samples in the set of non-local samples and the total number of samples in the set of local samples multiplied by the one non-local sample weight plus the total number of samples in the set of local samples multiplied by the local sample weight. In some implementations, the range of hyperparameters may be determined by, for any one non-local sample weight, determining an associated hyperparameter to be a ratio of a sum of local sample weights assigned to the one or more samples of the set of local samples to a sum of non-local sample weights assigned to the one or more samples of the set of non-local samples plus the sum of local sample weights assigned to the one or more samples of the set of local samples.

In step 212, an optimized hyperparameter may be determined based on the range of hyperparameters. For example, the range of hyperparameters may be utilized by a machine learning model and performance may be evaluated based on one or more predetermined metrics. Based on the performance results, an optimal hyperparameter may be selected. In some implementations, an optimized hyperparameter may be determined by performing a grid search. in some implementations, an optimized hyperparameter may be determined by utilizing a Bayesian optimization.

In step 214, an optimized non-local sample weight may be assigned to one or more samples of the set of non-local samples. In various implementations, the optimized non-local sample weight may be based on an optimized hyperparameter. For example, the optimized non-local sample weight may be the optimized hyperparameter.

In step 216, a prediction associated with the first entity may be generated using machine learning. For example, a machine learning model may be utilized to process the set of local samples with the local sample weight and the set of non-local samples with the optimized non-local sample weight in order to generate a prediction associated with the first entity. In some implementations, the prediction may be a prediction of an action to be taken by one or more individuals associated with the first entity.

As disclosed herein, determining an optimized hyperparameter for influencing non-local samples in machine learning may enable improved performance of a machine learning model by ensuring a sufficient amount of training data without losing personalization of a target entity. In a traditional approach, data from a single organization may be utilized to train a machine learning prediction model. However, such data may be limited (i.e., too small of a data sample) to sufficiently train the model. To offset the limited data of a single organization, data from a number of organizations may be used. The problem with using data from multiple organizations is that the various organizations may not be identical or sufficiently similar to accurately model for the target organization. By identifying an appropriate sample weight to be applied to data from other organizations, an amount of dissimilarity with the target organization may be minimized and the accuracy of the model may be improved. As such, the disclosed subject matter enables a machine learning prediction model to train using a larger set of data and, in turn, provide a more accurate prediction.

One or more parts of the above implementations may include software. Software is a general term whose meaning can range from part of the code and/or metadata of a single computer program to the entirety of multiple programs. A computer program (also referred to as a program) comprises code and optionally data. Code (sometimes referred to as computer program code or program code) comprises software instructions (also referred to as instructions). Instructions may be executed by hardware to perform operations. Executing software includes executing code, which includes executing instructions. The execution of a program to perform a task involves executing some or all of the instructions in that program.

An electronic device (also referred to as a device, computing device, computer, etc.) includes hardware and software. For example, an electronic device may include a set of one or more processors coupled to one or more machine-readable storage media (e.g., non-volatile memory such as magnetic disks, optical disks, read only memory (ROM), Flash memory, phase change memory, solid state drives (SSDs)) to store code and optionally data. For instance, an electronic device may include non-volatile memory (with slower read/write times) and volatile memory (e.g., dynamic random-access memory (DRAM), static random-access memory (SRAM)). Non-volatile memory persists code/data even when the electronic device is turned off or when power is otherwise removed, and the electronic device copies that part of the code that is to be executed by the set of processors of that electronic device from the non-volatile memory into the volatile memory of that electronic device during operation because volatile memory typically has faster read/write times. As another example, an electronic device may include a non-volatile memory (e.g., phase change memory) that persists code/data when the electronic device has power removed, and that has sufficiently fast read/write times such that, rather than copying the part of the code to be executed into volatile memory, the code/data may be provided directly to the set of processors (e.g., loaded into a cache of the set of processors). In other words, this non-volatile memory operates as both long term storage and main memory, and thus the electronic device may have no or only a small amount of volatile memory for main memory.

In addition to storing code and/or data on machine-readable storage media, typical electronic devices can transmit and/or receive code and/or data over one or more machine-readable transmission media (also called a carrier) (e.g., electrical, optical, radio, acoustical or other forms of propagated signals—such as carrier waves, and/or infrared signals). For instance, typical electronic devices also include a set of one or more physical network interface(s) to establish network connections (to transmit and/or receive code and/or data using propagated signals) with other electronic devices. Thus, an electronic device may store and transmit (internally and/or with other electronic devices over a network) code and/or data with one or more machine-readable media (also referred to as computer-readable media).

Software instructions (also referred to as instructions) are capable of causing (also referred to as operable to cause and configurable to cause) a set of processors to perform operations when the instructions are executed by the set of processors. The phrase “capable of causing” (and synonyms mentioned above) includes various scenarios (or combinations thereof), such as instructions that are always executed versus instructions that may be executed. For example, instructions may be executed: 1) only in certain situations when the larger program is executed (e.g., a condition is fulfilled in the larger program; an event occurs such as a software or hardware interrupt, user input (e.g., a keystroke, a mouse-click, a voice command); a message is published, etc.); or 2) when the instructions are called by another program or part thereof (whether or not executed in the same or a different process, thread, lightweight thread, etc.). These scenarios may or may not require that a larger program, of which the instructions are a part, be currently configured to use those instructions (e.g., may or may not require that a user enables a feature, the feature or instructions be unlocked or enabled, the larger program is configured using data and the program's inherent functionality, etc.). As shown by these exemplary scenarios, “capable of causing” (and synonyms mentioned above) does not require “causing” but the mere capability to cause. While the term “instructions” may be used to refer to the instructions that when executed cause the performance of the operations described herein, the term may or may not also refer to other instructions that a program may include. Thus, instructions, code, program, and software are capable of causing operations when executed, whether the operations are always performed or sometimes performed (e.g., in the scenarios described previously). The phrase “the instructions when executed” refers to at least the instructions that when executed cause the performance of the operations described herein but may or may not refer to the execution of the other instructions.

Electronic devices are designed for and/or used for a variety of purposes, and different terms may reflect those purposes (e.g., user devices, network devices). Some user devices are designed to mainly be operated as servers (sometimes referred to as server devices), while others are designed to mainly be operated as clients (sometimes referred to as client devices, client computing devices, client computers, or end user devices; examples of which include desktops, workstations, laptops, personal digital assistants, smartphones, wearables, augmented reality (AR) devices, virtual reality (VR) devices, mixed reality (MR) devices, etc.). The software executed to operate a user device (typically a server device) as a server may be referred to as server software or server code), while the software executed to operate a user device (typically a client device) as a client may be referred to as client software or client code. A server provides one or more services (also referred to as serves) to one or more clients.

The term “user” refers to an entity (e.g., an individual person) that uses an electronic device. Software and/or services may use credentials to distinguish different accounts associated with the same and/or different users. Users can have one or more roles, such as administrator, programmer/developer, and end user roles. As an administrator, a user typically uses electronic devices to administer them for other users, and thus an administrator often works directly and/or indirectly with server devices and client devices.

FIG. 3A is a block diagram illustrating an electronic device 300 according to some example implementations. FIG. 3A includes hardware 320 comprising a set of one or more processor(s) 322, a set of one or more network interfaces 324 (wireless and/or wired), and machine-readable media 326 having stored therein software 328 (which includes instructions executable by the set of one or more processor(s) 322). The machine-readable media 326 may include non-transitory and/or transitory machine-readable media. Each of the previously described clients and consolidated order manager may be implemented in one or more electronic devices 300.

During operation, an instance of the software 328 (illustrated as instance 306 and referred to as a software instance; and in the more specific case of an application, as an application instance) is executed. In electronic devices that use compute virtualization, the set of one or more processor(s) 322 typically execute software to instantiate a virtualization layer 308 and one or more software container(s) 304A-304R (e.g., with operating system-level virtualization, the virtualization layer 308 may represent a container engine running on top of (or integrated into) an operating system, and it allows for the creation of multiple software containers 304A-304R (representing separate user space instances and also called virtualization engines, virtual private servers, or jails) that may each be used to execute a set of one or more applications; with full virtualization, the virtualization layer 308 represents a hypervisor (sometimes referred to as a virtual machine monitor (VMM)) or a hypervisor executing on top of a host operating system, and the software containers 304A-304R each represent a tightly isolated form of a software container called a virtual machine that is run by the hypervisor and may include a guest operating system; with para-virtualization, an operating system and/or application running with a virtual machine may be aware of the presence of virtualization for optimization purposes). Again, in electronic devices where compute virtualization is used, during operation, an instance of the software 328 is executed within the software container 304A on the virtualization layer 308. In electronic devices where compute virtualization is not used, the instance 306 on top of a host operating system is executed on the “bare metal” electronic device 300. The instantiation of the instance 306, as well as the virtualization layer 308 and software containers 304A-304R if implemented, are collectively referred to as software instance(s) 302.

Alternative implementations of an electronic device may have numerous variations from that described above. For example, customized hardware and/or accelerators might also be used in an electronic device.

FIG. 3B is a block diagram of a deployment environment according to some example implementations. A system 340 includes hardware (e.g., a set of one or more server devices) and software to provide service(s) 342, including a consolidated order manager. In some implementations the system 340 is in one or more datacenter(s). These datacenter(s) may be: 1) first party datacenter(s), which are datacenter(s) owned and/or operated by the same entity that provides and/or operates some or all of the software that provides the service(s) 342; and/or 2) third-party datacenter(s), which are datacenter(s) owned and/or operated by one or more different entities than the entity that provides the service(s) 342 (e.g., the different entities may host some or all of the software provided and/or operated by the entity that provides the service(s) 342). For example, third-party datacenters may be owned and/or operated by entities providing public cloud services.

The system 340 is coupled to user devices 380A-380S over a network 382. The service(s) 342 may be on-demand services that are made available to one or more of the users 384A-384S working for one or more entities other than the entity which owns and/or operates the on-demand services (those users sometimes referred to as outside users) so that those entities need not be concerned with building and/or maintaining a system, but instead may make use of the service(s) 342 when needed (e.g., when needed by the users 384A-384S). The service(s) 342 may communicate with each other and/or with one or more of the user devices 380A-380S via one or more APIs (e.g., a REST API). In some implementations, the user devices 380A-380S are operated by users 384A-384S, and each may be operated as a client device and/or a server device. In some implementations, one or more of the user devices 380A-380S are separate ones of the electronic device 300 or include one or more features of the electronic device 300.

In some implementations, the system 340 is a multi-tenant system (also known as a multi-tenant architecture). The term multi-tenant system refers to a system in which various elements of hardware and/or software of the system may be shared by one or more tenants. A multi-tenant system may be operated by a first entity (sometimes referred to a multi-tenant system provider, operator, or vendor; or simply a provider, operator, or vendor) that provides one or more services to the tenants (in which case the tenants are customers of the operator and sometimes referred to as operator customers). A tenant includes a group of users who share a common access with specific privileges. The tenants may be different entities (e.g., different companies, different departments/divisions of a company, and/or other types of entities), and some or all of these entities may be vendors that sell or otherwise provide products and/or services to their customers (sometimes referred to as tenant customers). A multi-tenant system may allow each tenant to input tenant specific data for user management, tenant-specific functionality, configuration, customizations, non-functional properties, associated applications, etc. A tenant may have one or more roles relative to a system and/or service. For example, in the context of a customer relationship management (CRM) system or service, a tenant may be a vendor using the CRM system or service to manage information the tenant has regarding one or more customers of the vendor. As another example, in the context of Data as a Service (DAAS), one set of tenants may be vendors providing data and another set of tenants may be customers of different ones or all of the vendors' data. As another example, in the context of Platform as a Service (PAAS), one set of tenants may be third-party application developers providing applications/services and another set of tenants may be customers of different ones or all of the third-party application developers.

Multi-tenancy can be implemented in different ways. In some implementations, a multi-tenant architecture may include a single software instance (e.g., a single database instance) which is shared by multiple tenants; other implementations may include a single software instance (e.g., database instance) per tenant; yet other implementations may include a mixed model; e.g., a single software instance (e.g., an application instance) per tenant and another software instance (e.g., database instance) shared by multiple tenants.

In one implementation, the system 340 is a multi-tenant cloud computing architecture supporting multiple services, such as one or more of the following types of services: Customer relationship management (CRM); Configure, price, quote (CPQ); Business process modeling (BPM); Customer support; Marketing; Productivity; Database-as-a-Service; Data-as-a-Service (DAAS or DaaS); Platform-as-a-service (PAAS or PaaS); Infrastructure-as-a-Service (IAAS or IaaS) (e.g., virtual machines, servers, and/or storage); Analytics; Community; Internet-of-Things (IoT); Industry-specific; Artificial intelligence (AI); Application marketplace (“app store”); Data modeling; Security; and Identity and access management (IAM). For example, system 340 may include an application platform 344 that enables PAAS for creating, managing, and executing one or more applications developed by the provider of the application platform 344, users accessing the system 340 via one or more of user devices 380A-380S, or third-party application developers accessing the system 340 via one or more of user devices 380A-380S.

In some implementations, one or more of the service(s) 342 may use one or more multi-tenant databases 346, as well as system data storage 350 for system data 352 accessible to system 340. In certain implementations, the system 340 includes a set of one or more servers that are running on server electronic devices and that are configured to handle requests for any authorized user associated with any tenant (there is no server affinity for a user and/or tenant to a specific server). The user devices 380A-380S communicate with the server(s) of system 340 to request and update tenant-level data and system-level data hosted by system 340, and in response the system 340 (e.g., one or more servers in system 340) automatically may generate one or more Structured Query Language (SQL) statements (e.g., one or more SQL queries) that are designed to access the desired information from the multi-tenant database(s) 346 and/or system data storage 350.

In some implementations, the service(s) 342 are implemented using virtual applications dynamically created at run time responsive to queries from the user devices 380A-380S and in accordance with metadata, including: 1) metadata that describes constructs (e.g., forms, reports, workflows, user access privileges, business logic) that are common to multiple tenants; and/or 2) metadata that is tenant specific and describes tenant specific constructs (e.g., tables, reports, dashboards, interfaces, etc.) and is stored in a multi-tenant database. To that end, the program code 360 may be a runtime engine that materializes application data from the metadata; that is, there is a clear separation of the compiled runtime engine (also known as the system kernel), tenant data, and the metadata, which makes it possible to independently update the system kernel and tenant-specific applications and schemas, with virtually no risk of one affecting the others. Further, in one implementation, the application platform 344 includes an application setup mechanism that supports application developers' creation and management of applications, which may be saved as metadata by save routines. Invocations to such applications, including the framework for modeling heterogeneous feature sets, may be coded using Procedural Language/Structured Object Query Language (PL/SOQL) that provides a programming language style interface. Invocations to applications may be detected by one or more system processes, which manages retrieving application metadata for the tenant making the invocation and executing the metadata as an application in a software container (e.g., a virtual machine).

Network 382 may be any one or any combination of a LAN (local area network), WAN (wide area network), telephone network, wireless network, point-to-point network, star network, token ring network, hub network, or other appropriate configuration. The network may comply with one or more network protocols, including an Institute of Electrical and Electronics Engineers (IEEE) protocol, a 3rd Generation Partnership Project (3GPP) protocol, a 4^{th} generation wireless protocol (4G) (e.g., the Long Term Evolution (LTE) standard, LTE Advanced, LTE Advanced Pro), a fifth generation wireless protocol (5G), and/or similar wired and/or wireless protocols, and may include one or more intermediary devices for routing data between the system 340 and the user devices 380A-380S.

Each user device 380A-380S (such as a desktop personal computer, workstation, laptop, Personal Digital Assistant (PDA), smartphone, smartwatch, wearable device, augmented reality (AR) device, virtual reality (VR) device, etc.) typically includes one or more user interface devices, such as a keyboard, a mouse, a trackball, a touch pad, a touch screen, a pen or the like, video or touch free user interfaces, for interacting with a graphical user interface (GUI) provided on a display (e.g., a monitor screen, a liquid crystal display (LCD), a head-up display, a head-mounted display, etc.) in conjunction with pages, forms, applications and other information provided by system 340. For example, the user interface device can be used to access data and applications hosted by system 340, and to perform searches on stored data, and otherwise allow one or more of users 384A-384S to interact with various GUI pages that may be presented to the one or more of users 384A-384S. User devices 380A-380S might communicate with system 340 using TCP/IP (Transfer Control Protocol and Internet Protocol) and, at a higher network level, use other networking protocols to communicate, such as Hypertext Transfer Protocol (HTTP), File Transfer Protocol (FTP), Andrew File System (AFS), Wireless Application Protocol (WAP), Network File System (NFS), an application program interface (API) based upon protocols such as Simple Object Access Protocol (SOAP), Representational State Transfer (REST), etc. In an example where HTTP is used, one or more user devices 380A-380S might include an HTTP client, commonly referred to as a “browser,” for sending and receiving HTTP messages to and from server(s) of system 340, thus allowing users 384A-384S of the user devices 380A-380S to access, process and view information, pages and applications available to it from system 340 over network 382.

In the above description, numerous specific details such as resource partitioning/sharing/duplication implementations, types and interrelationships of system components, and logic partitioning/integration choices are set forth in order to provide a more thorough understanding. The invention may be practiced without such specific details, however. In other instances, control structures, logic implementations, opcodes, means to specify operands, and full software instruction sequences have not been shown in detail since those of ordinary skill in the art, with the included descriptions, will be able to implement what is described without undue experimentation.

References in the specification to “one implementation,” “an implementation,” “an example implementation,” etc., indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, and/or characteristic is described in connection with an implementation, one skilled in the art would know to affect such feature, structure, and/or characteristic in connection with other implementations whether or not explicitly described.

For example, the figure(s) illustrating flow diagrams sometimes refer to the figure(s) illustrating block diagrams, and vice versa. Whether or not explicitly described, the alternative implementations discussed with reference to the figure(s) illustrating block diagrams also apply to the implementations discussed with reference to the figure(s) illustrating flow diagrams, and vice versa. At the same time, the scope of this description includes implementations, other than those discussed with reference to the block diagrams, for performing the flow diagrams, and vice versa.

Bracketed text and blocks with dashed borders (e.g., large dashes, small dashes, dot-dash, and dots) may be used herein to illustrate optional operations and/or structures that add additional features to some implementations. However, such notation should not be taken to mean that these are the only options or optional operations, and/or that blocks with solid borders are not optional in certain implementations.

The detailed description and claims may use the term “coupled,” along with its derivatives. “Coupled” is used to indicate that two or more elements, which may or may not be in direct physical or electrical contact with each other, co-operate or interact with each other.

While the flow diagrams in the figures show a particular order of operations performed by certain implementations, such order is exemplary and not limiting (e.g., alternative implementations may perform the operations in a different order, combine certain operations, perform certain operations in parallel, overlap performance of certain operations such that they are partially in parallel, etc.).

While the above description includes several example implementations, the invention is not limited to the implementations described and can be practiced with modification and alteration within the spirit and scope of the appended claims. The description is thus illustrative instead of limiting.

What is claimed is:

1. A computer-implemented for determining a hyperparameter for influencing non-local samples in machine learning, the method comprising:
identifying a set of local samples associated with a first entity;
identifying a set of non-local samples comprising samples associated with a plurality of entities other than the first entity;
assigning a local sample weight to one or more samples of the set of local samples;
determining a range of non-local sample weights;
determining a range of hyperparameters based on the range of non-local sample weights;
determining an optimized hyperparameter based on the range of hyperparameters;
assigning an optimized non-local sample weight to one or more samples of the set of non-local samples, the optimized non-local sample weight based on the optimized hyperparameter; and
generating a prediction using machine learning, the prediction associated with the first entity and being based on:
the set of local samples;
the set of non-local samples;
the local sample weight; and
the optimized non-local sample weight.

2. The computer-implemented method of claim 1, wherein the local sample weight is 1.

3. The computer-implemented method of claim 1, wherein the range of non-local sample weights is between:
a total number of samples in the set of local samples over a total number of samples in the set of local samples and the set of non-local samples; and
the integer value 1.

4. The computer-implemented method of claim 1, wherein determining a range of hyperparameters based on the range of non-local sample weights comprises, for any one non-local sample weight, determining an associated hyperparameter to be a ratio of a total number of samples in the set of local samples to a difference between a total number of samples in the set of non-local samples and the total number of samples in the set of local samples multiplied by the one non-local sample weight plus the total number of samples in the set of local samples.

5. The computer-implemented method of claim 1, wherein determining a range of hyperparameters based on the range of non-local sample weights comprises, for any one non-local sample weight, determining an associated hyperparameter to be a ratio of a total number of samples in the set of local samples multiplied by the local sample weight to a difference between a total number of samples in the set of non-local samples and the total number of samples in the set of local samples multiplied by the one non-local sample weight plus the total number of samples in the set of local samples multiplied by the local sample weight.

6. The computer-implemented method of claim 1, wherein determining a range of hyperparameters based on the range of non-local sample weights comprises, for any one non-local sample weight, determining an associated hyperparameter to be a ratio of a sum of local sample weights assigned to the one or more samples of the set of local samples to a sum of non-local sample weights assigned to the one or more samples of the set of non-local samples plus the sum of local sample weights assigned to the one or more samples of the set of local samples.

7. The computer-implemented method of claim 1, wherein determining an optimized hyperparameter based on the range of hyperparameters comprises performing a grid search.

8. The computer-implemented method of claim 1, wherein determining an optimized hyperparameter based on the range of hyperparameters comprises utilizing a Bayesian optimization.

9. The computer-implemented method of claim 1, wherein the prediction is a prediction of an action to be taken by one or more individuals associated with the first entity.

10. A non-transitory machine-readable storage medium that provides instructions that, if executed by a processor, are configurable to cause the processor to perform operations comprising:
identifying a set of local samples associated with a first entity;
identifying a set of non-local samples comprising samples associated with a plurality of entities other than the first entity;
assigning a local sample weight to one or more samples of the set of local samples;
determining a range of non-local sample weights;
determining a range of hyperparameters based on the range of non-local sample weights;
determining an optimized hyperparameter based on the range of hyperparameters;
assigning an optimized non-local sample weight to one or more samples of the set of non-local samples, the optimized non-local sample weight based on the optimized hyperparameter; and
generating a prediction using machine learning, the prediction associated with the first entity and being based on:
the set of local samples;
the set of non-local samples;
the local sample weight; and
the optimized non-local sample weight.

11. The non-transitory machine-readable storage medium of claim 10, wherein the range of non-local sample weights is between:
a total number of samples in the set of local samples over a total number of samples in the set of local samples and the set of non-local samples; and
the integer value 1.

12. The non-transitory machine-readable storage medium of claim 10, wherein determining a range of hyperparameters based on the range of non-local sample weights comprises, for any one non-local sample weight, determining an associated hyperparameter to be a ratio of a total number of samples in the set of local samples to a difference between a total number of samples in the set of non-local samples and the total number of samples in the set of local samples multiplied by the one non-local sample weight plus the total number of samples in the set of local samples.

13. The non-transitory machine-readable storage medium of claim 10, wherein determining an optimized hyperparameter based on the range of hyperparameters comprises performing a grid search.

14. The non-transitory machine-readable storage medium of claim 10, wherein determining an optimized hyperparameter based on the range of hyperparameters comprises utilizing a Bayesian optimization.

15. The non-transitory machine-readable storage medium of claim 10, wherein the prediction is a prediction of an action to be taken by one or more individuals associated with the first entity.

16. An apparatus comprising:
a processor; and
a non-transitory machine-readable storage medium that provides instructions that, if executed by a processor, are configurable to cause the processor to perform operations comprising:
identifying a set of local samples associated with a first entity;
identifying a set of non-local samples comprising samples associated with a plurality of entities other than the first entity;
assigning a local sample weight to one or more samples of the set of local samples;
determining a range of non-local sample weights;
determining a range of hyperparameters based on the range of non-local sample weights;
determining an optimized hyperparameter based on the range of hyperparameters;
assigning an optimized non-local sample weight to one or more samples of the set of non-local samples, the optimized non-local sample weight based on the optimized hyperparameter; and
generating a prediction using machine learning, the prediction associated with the first entity and being based on:
the set of local samples;
the set of non-local samples;
the local sample weight; and
the optimized non-local sample weight.

17. The apparatus of claim 16, wherein the range of non-local sample weights is between:
a total number of samples in the set of local samples over a total number of samples in the set of local samples and the set of non-local samples; and
the integer value 1.

18. The apparatus of claim 16, wherein determining a range of hyperparameters based on the range of non-local sample weights comprises, for any one non-local sample weight, determining an associated hyperparameter to be a ratio of a total number of samples in the set of local samples to a difference between a total number of samples in the set of non-local samples and the total number of samples in the set of local samples multiplied by the one non-local sample weight plus the total number of samples in the set of local samples.

19. The apparatus of claim 16, wherein determining an optimized hyperparameter based on the range of hyperparameters comprises performing a grid search.

20. The apparatus of claim 16, wherein determining an optimized hyperparameter based on the range of hyperparameters comprises utilizing a Bayesian optimization.
